(19) United States
(12) Patent Application Publication
(10) Pub. No.: US 2004/0195466 A1
(43) Pub. Date: Oct. 7, 2004

(54) Device for organizing cables connected to video camera secured on a tripod

(76) Inventor: Chan-Min Ma, Taipei (TW)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/407,046

(22) Filed: Apr. 3, 2003

(51) Int. Cl. F16L 3/22

(52) U.S. Cl. 248/68.1

(57) ABSTRACT

Disclosed is a device for organizing cables connected to a video camera secured on a tripod, comprising: a support; a plurality of cable clips mounted to the support for receiving the cables connected to the video camera, and a locking means provided at an end of the support, thereby preventing the cables received in the cable clips from tangling with peripheral devices connected to the video camera, other cables, or even the operator, and preventing incidental unplugging of the cables from sockets on the video camera or peripheral devices.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

The invention relates to a device for organizing cables connected to a video camera secured on a tripod. More particularly, the invention relates to a device for organizing cables connected to a video camera secured on a tripod so that the cables will not tangle with peripheral devices connected to the video camera or the operator.

2. Background

Video cameras are usually mounted on a tripod for stable manipulation and accordingly to obtain video of good quality. Video cameras, particularly the ones used professionally, are mounted on a tripod by way of a base plate. The base plate, mostly provided by the video camera supplier, serves as an adaptor for the video camera so that the camera can be quickly and easily mounted on and released from a tripod. When a video camera is to be mounted on a tripod, the base plate first joins the tripod, and then the video camera is mounted on the base plate. Alternatively, the base plate can join the video camera before being mounted on the tripod.

As shown in FIG. 1, the base plate 10 illustrated has already been mounted on a tripod 12.

The bottom of the video camera 14 includes a truncated triangle plate 16 with both sides each formed with a slope surface 17 and a U-shaped plate 18 with an indentation 20.

The base plate 10 has a recess 22 with a dovetailed guide 24 at each of its two sides so that the truncated triangle plate 16 can slide to engage the dovetailed guide 24.

The U-shaped plate 18 and a headed pin 26 serve as an auxiliary attachment force to engage the truncated triangle plate 16 with the dove-tailed guide 24, in which the headed pin 26 slidably inserts into the gap formed between the U-shaped plate 18 and the bottom surface of the video camera 14.

The base plate 10 provided by the supplier of the video camera is equipped with three screw holes 140, which have become standards for individual base plate supplier.

Once the video camera 14 is mounted onto the tripod 12 via the base plate 10, the video camera 14 is ready to be connected to peripheral devices, such as remote controllers, microphones, headsets, and servo electronic boxes, via cables. As the number of peripheral devices and cables needed to be connected to the video camera 14 increases, the chance of the operator tangling with the cables or of the cables tangling over one another increases as well. The risk of the operator incidentally pulling the cables off sockets on the video camera or the peripheral devices, may also increase, which may possibly cause the entire shooting operation to stop.

Anything like this is devastating, as the value of the camera is very expensive and the re-shooting takes time and efforts.

Therefore, a device for organizing cables connected to a video camera secured on a tripod is needed to overcome the foregoing problems without modifying the current design between the engagement of the camera and the base plate, which has become a standard.

### SUMMARY OF INVENTION

The present invention is directed to a device that satisfies the need of organizing cables connected to a video camera secured on a tripod.

The device comprises a support, a plurality of cable clips mounted to the support, and a locking means. The clips may include various dimensions to adapt to outer diameters of various cables connecting the video camera to peripheral devices. The locking means locks the device to a support adaptor mounted onto the tripod. Once the device is mounted onto the tripod, cables may be properly arranged and organized by clamping the cables into appropriate clips provided on the support.

With the device as described above, the cables connecting the video camera to the peripheral devices can be orderly arranged along the support without the disadvantage of tangling with one another or with the operator. Furthermore, the risk of the pulling the cables off sockets on the video camera or peripheral devices may also be effectively reduced.

### BRIEF DESCRIPTION OF THE DRAWINGS

These and other modifications and advantages will become even more apparent from the following detained description of a preferred embodiment of the invention and from the drawings in which:

FIG. 1 shows the bottom of a video camera and a base plate mounted on a tripod;

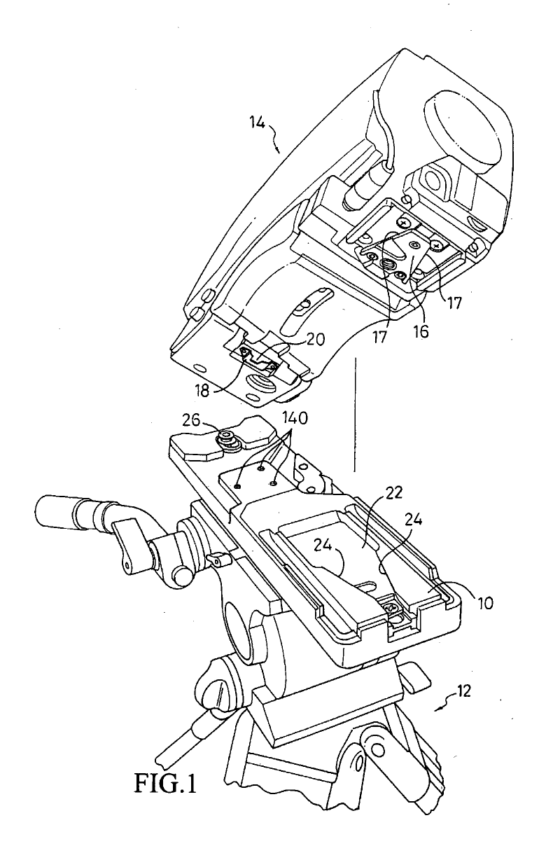

FIG. 2 shows the device according to the present invention in the condition, wherein the support adaptor mounted onto the tripod is shown in phantom lines;

FIG. 3 shows a perspective view of how the support adaptor for use with the device is mounted onto the base plate; and

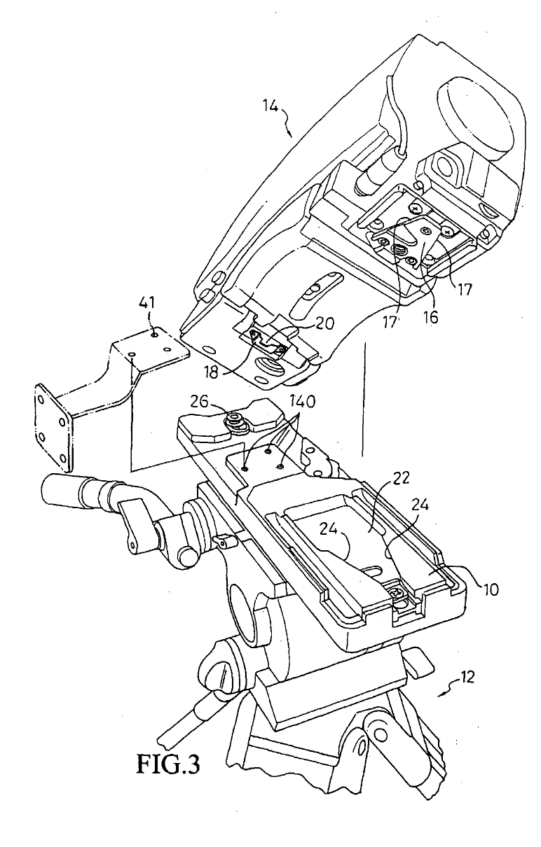

FIG. 4 shows applications of the device according to the present invention once it is locked to the support adaptor mounted onto the tripod,

### DETAILED DESCRIPTION OF THE INVENTION (PREFERRED EMBODIMENTS)

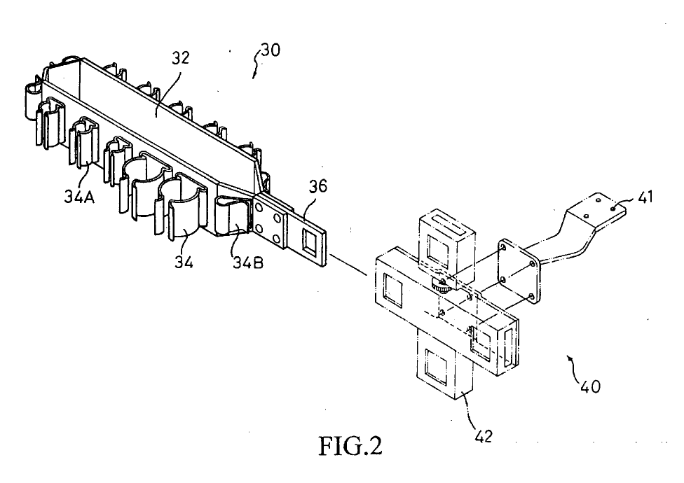

Referring to FIG. 2, the device for organizing cables connected to a video camera 14 secured onto a tripod 12 is designated by the numeral 30. The device 30 primarily includes: a support 32, a plurality of cable clips 34, 34A, 34B mounted to the support 32, and a locking means 36.

The support 32 has a generally elongated configuration and is made of a rigid material.

The clips 34, 34A, 34B may include various dimensions to adapt to different outer diameters of various cables connecting the video camera to peripheral devices. For example, the clips 34 shown in FIG. 2 are configured of to have larger diameter than the clips 34A are. Furthermore, the clip 34B is of a “side-clip” type that allows a cable clipped therein to be easily pulled away if forces are exerted on the cables, used by the operator at desires.

Preferably, the clips 34, 34A, 34B are mounted to the support 32 in an orderly fashion, such as being parallel to one another so as to facilitate organization of the cables received therein.

The locking means 36 locks the device 30 to a support adaptor 40 mounted onto the tripod 12. In general, the support adaptor 40 is made to adapt to the profile of the bottom portion of a video camera 14 and contains the same number of holes 41 as that base plate 10, so as to be fastened to the base plate 10 associated with the camera 14 by way of screws. The support adaptor may also adapt to other part of the tripod 12.

The support adaptor 40 is further provided with a four-way locking mechanism 42 that may be mated with the locking means 36 the device of the present invention. Details of the support adaptors are described in a co-pending patent application, entitled “Side Wing Support Adaptor Accommodating Accessory of Tripod,” filed by the same applicant, and the content of the co-pending patent application is incorporated herewith as part of the patent specification.

Once the device 30 is mounted onto the tripod 12, cables may then be properly arranged and organized by clamping the cables into appropriate clips 34, 34A, 34B provided on the support 32.

In this embodiment, the locking means 36 is a latch fixed at one end of the support 32 to allow releasable connection with the support adaptor 40 provided with a latch release.

The provisions of the locking means 36 and mating means provided on the support adaptor 40 may be interchanged. For example, the locking means 36 may be a latch release while the support adaptor 40 is provided with a latch, so long as the two locking means 36 and the support adaptor 40 can properly mate and lock to one another.

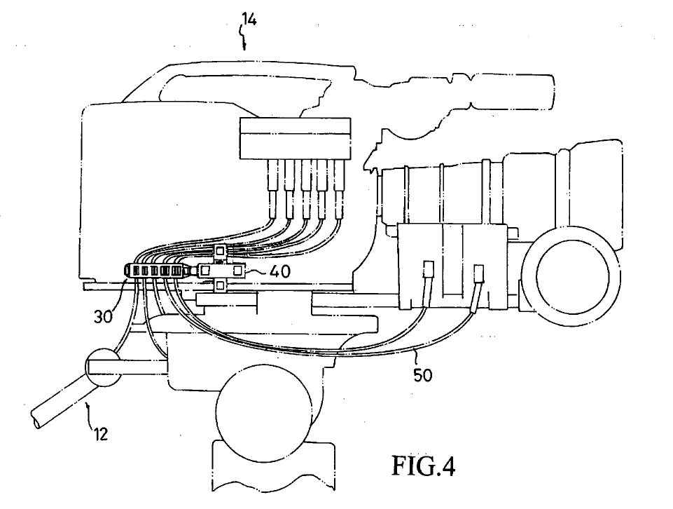

In operation, the support adaptor 40 is first mounted onto the base plate 10 before the video camera 14 slides to lock onto the base plate 10. The device 30 is then latched to the support adaptor 40 by means of the locking means 36, as shown in FIG. 4.

At this time, the video camera 14 is ready to be connected to peripheral devices, such as remote controllers, microphones, headsets, and servo electronic boxes, via cables 50 (FIG. 4).

The cables 50 may, thus, be properly arranged and organized by clamping respective cables 50 into appropriate clips 34, 34A, 34B provided on the support 32.

As such, the cables 50 are prevented from tangling with peripheral devices connected to the video camera, other cables, or even the operator. At the same time, if any of the peripheral devices are worn by the operator, who may incidentally pull on the cables of the peripheral devices, the cables will be secured by clips 34, 34A, 34B so as to prevent incidental unplugging of the cables from sockets on the video camera 14 or peripheral devices.

It will thus be seen that the invention efficiently attains the objects set forth above, among those made apparent from the preceding description. Since certain changes may be made in the above constructions without departing from the scope of the invention, all matters contained in the above description or shown in the accompanying drawings are intended to be interpreted as illustrative and not in a limiting sense.

1. A device for organizing cables connected to a video camera secured onto a tripod by means of a base plate provided between the video camera and the tripod, comprising:
a support having two opposing sides and a hollow region formed between the opposing sides;
a plurality of cable clips mounted to at least one of the two opposing sides of the support for receiving the cables connected to the video camera;
a support adaptor having a first end and a second end, the first end being mounted to the base plate; and
a locking means provided at an end of the support for quick releasably locking the support to the support adaptor at the second end of the support adaptor.

2. The device of claim 1, wherein the support has a generally elongated configuration and is made of a rigid material.

3. The device of claim 1, wherein the clips include various dimensions to adapt to different outer diameters of various cables connecting to the video camera to be inserted through the clips.

4. The device of claim 1, wherein the clips are mounted to the opposing sides of the support in an orderly fashion.

5. The device of claim 4, wherein the clips are mounted to the opposing sides of the support in such a matter that they are parallel to one another.

6. (Canceled)

7. The device of claim 1, wherein the locking means is a latch fixed at one end of the support, and wherein the support adaptor is provided with a mating latch release allowing releasable connection between the support and the support adaptor.

8. The device of claim 1, wherein the locking means is a latch release fixed at one end of the support, and wherein the support adaptor is provided with a mating latch allowing releasable connection between the support and the support adaptor.

9. A device for organizing cables connected to a video camera secured onto a tripod by a base plate provided between the video camera and the tripod, comprising:
a support having two opposing sides and a hollow region formed between the opposite sides;
a plurality of cable clips mounted to at least one of the two opposing sides of the support for receiving the cables connected to the video camera;
a support adaptor having a first end and a second end, the first end being mounted to the base plate; and
a locking member provided at an end of the support for quick releasably locking the support to the support adaptor at the second end of the support adaptor.

10. The device of claim 9, wherein the locking member is a latch fixed at one end of the support, and wherein the support adaptor provides releasable connection between the support and the support adaptor.

11. The device of claim 9, wherein the locking member is a latch release fixed at one end of the support, and wherein the support adaptor provides releasable connection between the support and the support adaptor.
